(19) United States
(12) Patent Application Publication
(10) Pub. No.: US 2025/0247342 A1
(43) Pub. Date: Jul. 31, 2025

(54) INFORMATION HANDLING SYSTEM WITH MULTIPLE FORWARDING ELEMENTS FOR PARALLEL DATA HANDLING

(71) Applicant: DELL PRODUCTS L.P., Round Rock, TX (US)

(72) Inventors: Claudio DESANTI, Santa Cruz, CA (US); Jonathan STREETE, South San Francisco, CA (US); Joseph LaSalle WHITE, San Jose, CA (US)

(73) Assignee: DELL PRODUCTS L.P., Round Rock, TX (US)

(21) Appl. No.: 18/425,957

(22) Filed: Jan. 29, 2024

(51) Int. Cl. H04L 49/111

(52) U.S. Cl. CPC H04L 49/111

(57) ABSTRACT

Currently, network forwarding elements, such as application specific integrated circuits (ASICs), provide several high-speed ports. However, in some cases, the number of ports they provide is not enough. A common solution to increase the number of available switched ports involves interconnecting multiple switching elements in a fabric topology. Such approaches add cost and complexity while reducing reliability. Accordingly, embodiments herein improve data handling for high data applications without significantly increasing network costs, complexity, or network cabling. Embodiments use fewer switches by configuring high-speed cables as a set (or sets) of parallel lanes operating at lower speeds. The parallel lanes may be connected to a network information handling system (e.g., an Ethernet switch) that comprises multiple network processor units arranged in a parallel configuration, which facilitates parallel data handling.

### BACKGROUND

### A. Technical Field

The present disclosure relates generally to information handling systems. More particularly, the present disclosure relates to facilitating parallelized data handling.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently available network forwarding elements, such as application specific integrated circuits (ASICs), provide several high-speed Ethernet ports. However, in many cases, the number of ports they provide is not enough for applications, such as Artificial Intelligence/Machine Learning (AI/ML) applications. Consider, by way of example, the Tomahawk® 4 switch chip (TH4), which is produced by Broadcom Inc. (a Delaware corporation headquartered in Palo Alto, California) and which provides 64 Ethernet ports operating at the speed of 400 Gb/s. FIG. 1 depicts a high-level graphical representation of the TH4 with its 64 ports. In this patent document, the TH4 forwarding element is provided by way of example; however, concepts disclosed herein are applicable to other forwarding elements (which may also be referred to as network processors or network processing units).

A common solution to increase the number of available switched ports is to interconnect multiple switching elements in a fabric topology, such as a spine-leaf topology. FIG. 2 shows an implementation that increases the number of available fabric ports from 64 ports to 256 ports using multiple Ethernet switches. The network 200 comprises two leaf layers 210 and 220 that connect to a spine layer 215. The spine-leaf fabric connects two host information handling systems 205 and 225. Note that the “8/” indicates that each line depicted in the spine-leaf topology represents 8 cables.

However, some of the drawbacks to an approach like that shown in FIG. 2 are the added cost and complexity-many switches are needed (in this example, 8 leaf switches and 4 spine switches) and many cables are needed to interconnect them (in this example, 256 cables). Not only do such “solutions” increase cost and complexity, but they also reduce reliability. There are more components that may fail and more chances for issues such as misconfiguration.

Accordingly, it is highly desirable to find new, more efficient ways to improve data handling for high data applications without significantly increasing network costs and complexity.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts a graphical representation of a 64-port forwarding element.

FIG. 2 depicts an example network topology that increases bandwidth, but also increases costs and complexity, while decreasing reliability.

FIG. 3 graphically depicts a forwarding element/network processor that is configured with 256 ports, according to embodiments of the present disclosure.

FIG. 4 depicts an example of a parallel topology.

FIG. 5 depicts a simplified block diagram of an information handling system, according to embodiments of the present disclosure.

FIG. 6 depicts an alternative block diagram of an information handling system, according to embodiments of the present disclosure.

FIG. 7A depicts a network link in which four communication lanes act as a single link.

FIG. 7B depicts a network link in which the four communication lanes are configured to operate as four parallel, distinct links, according to embodiments of the present disclosure.

FIG. 8A shows how to build a network information handling system comprising four (4) forwarding elements (or network processing units), according to embodiments of the present disclosure.

FIG. 8B depicts an alternate view of the network information handling system of FIG. 8A, according to embodiments of the present disclosure.

FIG. 9 depicts a network information handling system comprising four (4) forwarding elements, according to embodiments of the present disclosure.

FIG. 10 illustrates a network information handling system that can operate as an Ethernet parallel switch, according to embodiments of the present disclosure.

FIG. 11 illustrates a network information handling system that can operate as an Ethernet parallel switch that has eight forwarding elements, according to embodiments of the present disclosure.

FIG. 12 depicts a methodology for deploying and using a network information handling system in a parallel switch configuration, according to embodiments of the present disclosure.

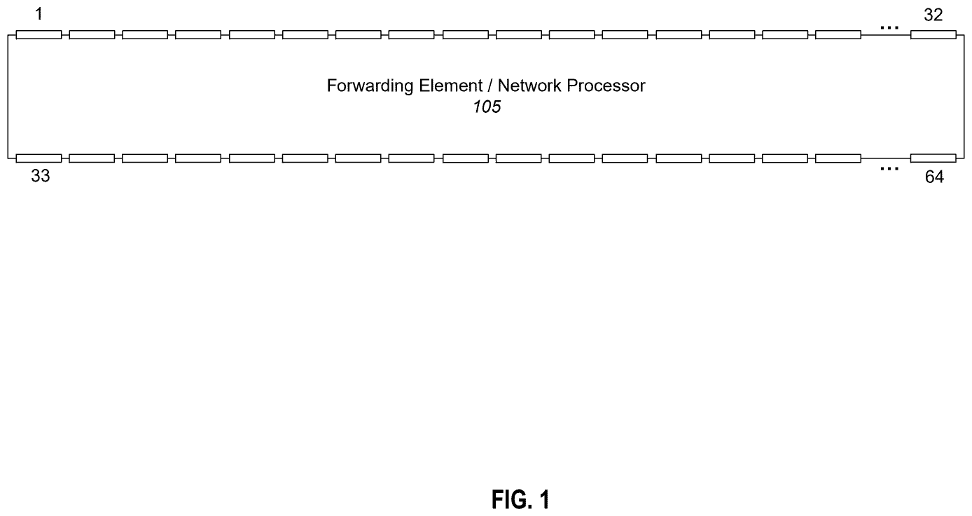

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document, if any, is incorporated by reference herein in its entirety.

It shall also be noted that although embodiments described herein may be within the context of network information handling system (e.g., network switches), aspects of the present disclosure are not so limited. Also, embodiments may be described in the context of Ethernet and associated protocols, such as Internet Protocol (IP) and Transmission Control Protocol (TCP); however, these embodiments are provided by way of illustration and not limitation-embodiments may be used with other technologies and protocols. Accordingly, the aspects of the present disclosure may be applied or adapted for use in other contexts.

### A. GENERAL INTRODUCTION

As noted above, prior approaches to increase bandwidth typically involved increasing the number of network devices. However, such approaches add cost and complexity while reducing reliability.

Given the traffic patterns of certain applications, such as artificial intelligence/machine learning (AI/ML), it is possible to enable alternative solutions. While AI/ML applications utilize a lot of bandwidth, AI/ML data is often highly parallelized or parallelizable. AI/ML application lends itself to have highly parallelizable data due to a number of factors. First, for many machine learning tasks, at least some of the data is independent of each other. Therefore, the computation for one data point does not depend on the results of another. This independence allows for parallel processing of multiple data points simultaneously. Second, given the vast amounts of data involved in AI/ML applications, batch processing is commonly employed. Batch processing involves processing sets of data in tranches and then, if needed, combining the results. Many AI/ML algorithms operate on batches of data, which allows for parallel data handling. Batch processing is also employed due to the nature of training machine learning models. There is often too much data to be processed in one operation, so it must be divided into batches. Also, due to the volume of data, it would take too long to perform model training or optimization using a single system; therefore, batches allow for parallelization so that processing can be distributed across multiple processors or machines. For similar reasons as stated above regarding data size and processing time, many AI/ML applications/algorithms are inherently designed to be parallel. The architecture of an AI/ML model also lends itself to parallelization. For example, in deep learning, the different layers of neural networks may be computed in parallel (e.g., parallel computation of gradients for different layers of the network). Furthermore, AI/ML applications/algorithms typically involve high-dimensional data with many matrix operations. These matrix computations and the dimensions may be parallelized and independently processed. Finally, distributed computing frameworks (e.g., Apache Spark, TensorFlow, PyTorch) have been developed to support distributed computations across multiple nodes in a cluster, allowing for efficient parallel processing.

Embodiment herein leverage that a high-speed Ethernet interface may be decomposed into multiple lower speed interfaces and that applications with parallelizable data (e.g., AI/ML traffic) may be handled by multiple parallel channels operating at lower speeds—as opposed to being handled with a single channel operating at a higher speed. For example, in one or more embodiments, on the host side, Ethernet NICs (network interface cards) support a bandwidth of 400 Gb/s, which can be handled as:
1 port at 400 Gb/s;
2 ports at 200 Gb/s; or
4 ports at 100 Gb/s.

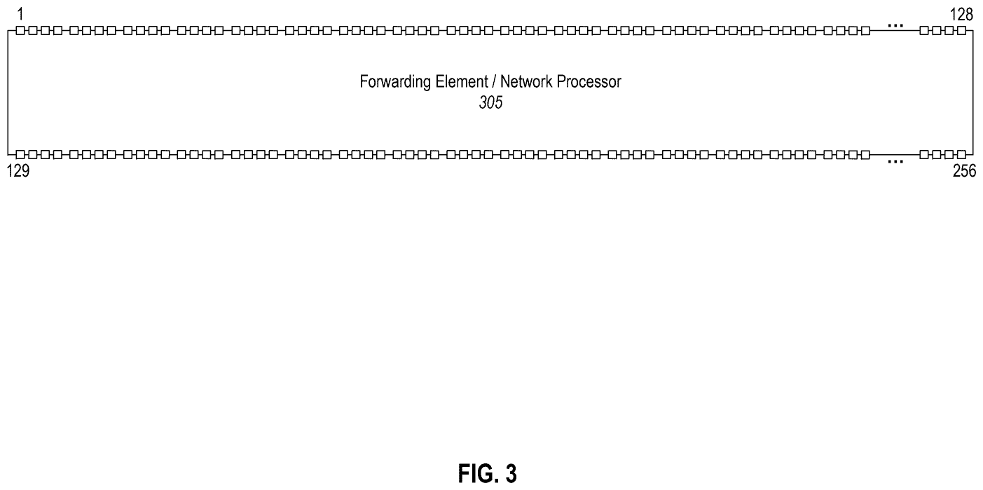

On the network information handling system side (e.g., on the switch side), forwarding elements, such as TH4s, may be configured to act as a 256-port Ethernet switch with each port operating at the speed of 100 Gb/s. FIG. 3 graphically depicts a forwarding element/network processor that is configured with 256 ports.

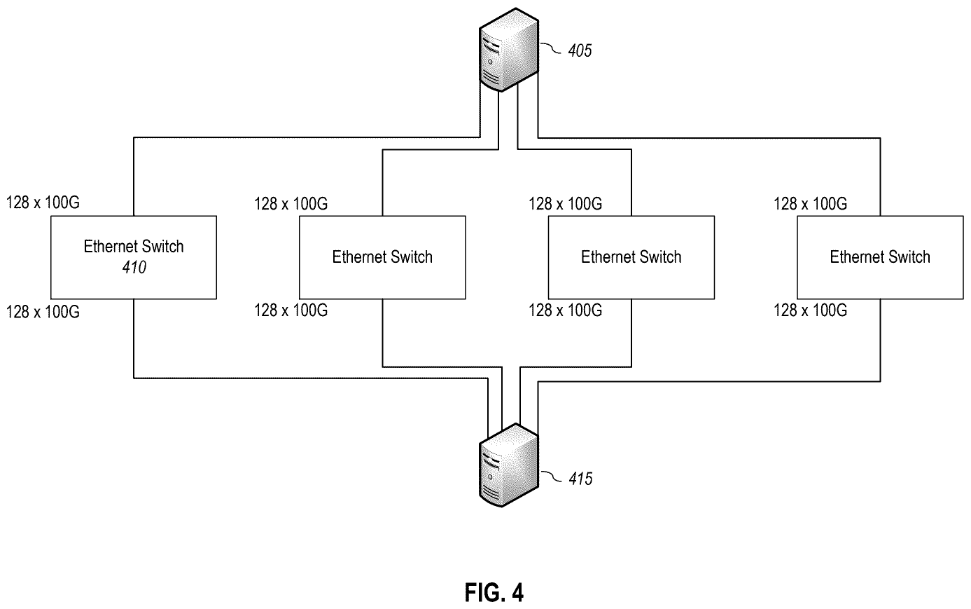

These alterations enable embodiments to scale the number of fabric ports. In one or more embodiments, embodiments may be considered to be based on a “parallel topology” (i.e., a fabric comprising a set of parallel networks in which each end node is connected to each network). An example of parallel topology is shown in FIG. 4.

In the example configuration depicted in FIG. 4, the host Ethernet ports may be configured as 4 ports operating at 100 Gb/s (e.g., the 4 ports of host 405 are configured to operate at 100 Gb/s). Similarly, the ports of the Ethernet switches (e.g., switch 410) may be configured to operate at 100 Gb/s, and breakout cables or multiple cables are used to connect each of the four host ports to a port per switch.

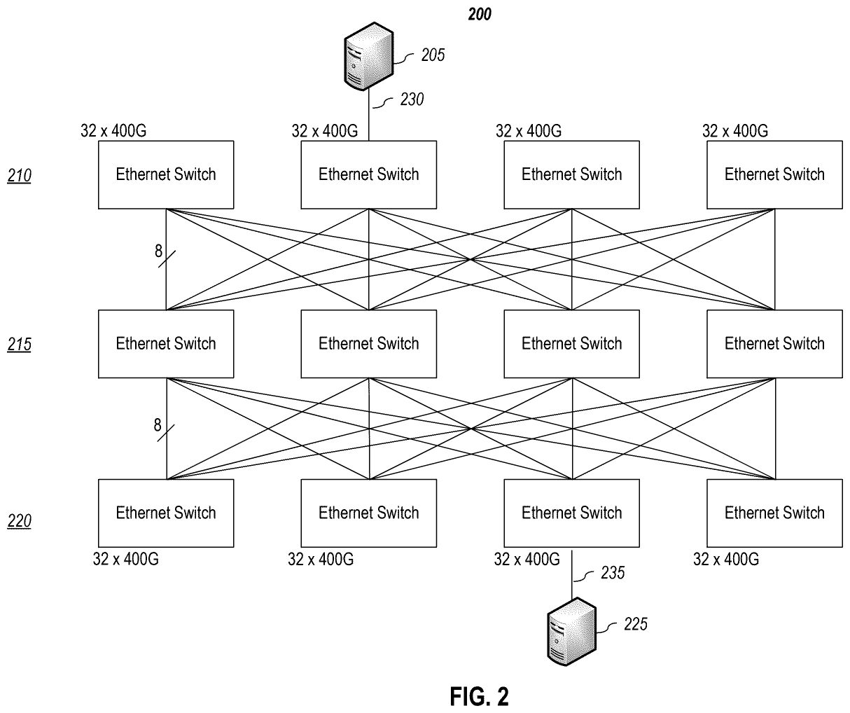

It should be noted that the configuration shown in FIG. 4 uses fewer switches than the implementation in FIG. 3, but it provides the same aggregate bandwidth as the implementation shown in FIG. 2 by leveraging a higher number of parallel channels. This simplification is possible for use cases that lend themselves to parallelization, such as AI/ML, because for such use cases providing an overall bandwidth of 400 Gb/s per host as an aggregation of four lower speed ports works as well (or nearly as well) as having the bandwidth provided as a single port at 400 Gb/s link speed.

While embodiments like that of FIG. 4 provide some benefits, such configurations add some complexity to the cabling on the host side by having to bring in a cable from each switch to a given host. Consider by way of comparison, the implementation of FIG. 2 versus the implementation in FIG. 4. In FIG. 2, each of the hosts only needed one connection from the fabric (e.g., connection 230 for host 205 and connection 235 for host 225). However, in FIG. 4, there are four connections to each host. Thus, embodiments enabling fewer switches as in FIG. 4 without complicating the host cabling are highly desirable.

As provided in more detail in the next section, embodiments include novel parallel switch designs that comprise multiple internal forwarding elements/network processor. In one or more embodiments, each internal network processor may be configured to support its maximum number of ports, even if at lower speeds (e.g., configuring a TH4 to operate as a 256×100GE ports network processor ASIC rather than a 64×400GE ports network processor ASIC). Also, in one or more embodiments, the number of lanes on an externally accessible switch connector (and/or transceiver) may be tied to the number of internal network processors, to enable parallel switching of each lane.

One skilled in the art shall recognize several benefits of the novel parallel design concepts for a network switching information handling system. For example, among other benefits, embodiments simplify the cabling of a computing infrastructure and increase the maximum number of ports supported by a single-hop Ethernet switch.

### B. SYSTEM AND METHOD EMBODIMENTS

In one or more embodiments, aspects of the present patent document may be directed to, may include, or may be implemented on one or more information handling systems (or computing systems), which may function as a network devices or host devices. An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

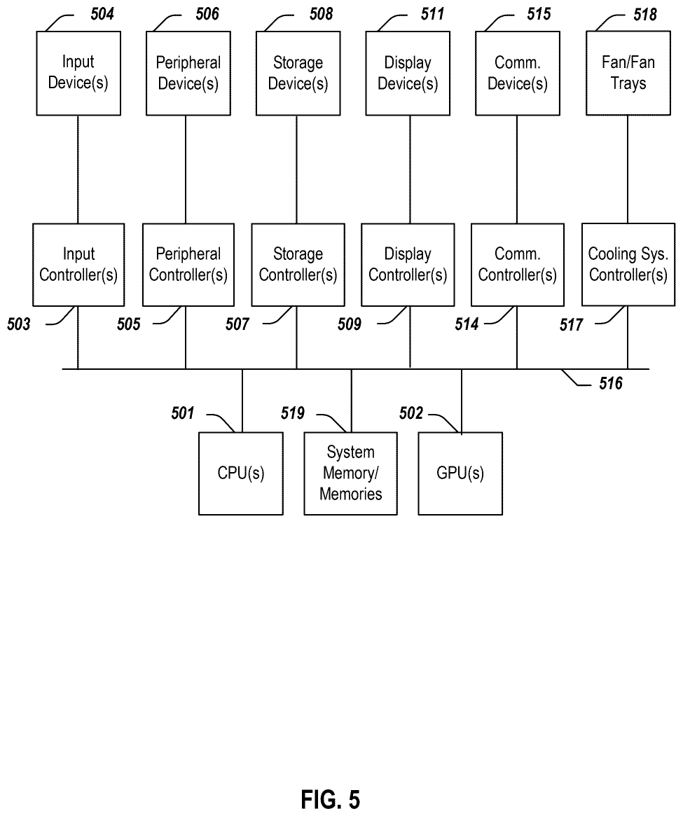

FIG. 5 depicts a simplified block diagram of an information handling system (or computing system), according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provides computing resources and controls the computer. CPU 501 may be implemented with a microprocessor or the like and may also include one or more graphics processing units (GPU) 502 and/or a floating-point coprocessor for mathematical computations. In one or more embodiments, one or more GPUs 502 may be incorporated within the display controller 509, such as part of a graphics card or cards. The system 500 may also include a system memory 519, which may comprise RAM, ROM, or both.

A number of controllers and peripheral devices may also be provided, as shown in FIG. 5. An input controller 503 represents an interface to various input device(s) 504, such as a keyboard, mouse, touchscreen, stylus, microphone, camera, trackpad, display, etc. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 500 comprises one or more fans or fan trays 518 and a cooling subsystem controller or controllers 517 that monitors thermal temperature(s) of the system 500 (or components thereof) and operates the fans/fan trays 518 to help regulate the temperature.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

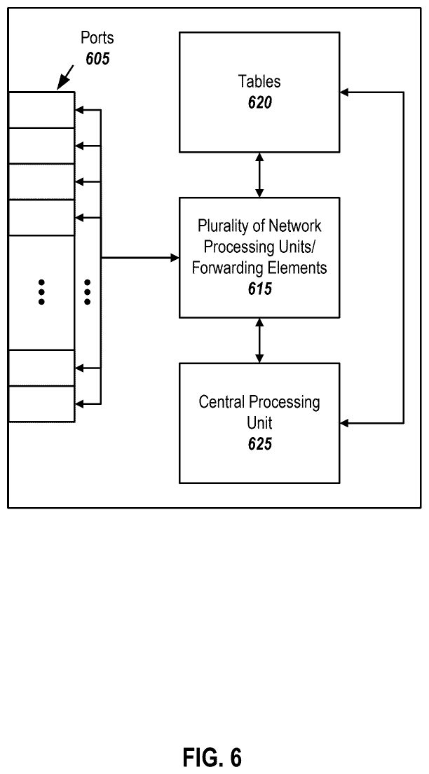

FIG. 6 depicts an alternative block diagram of an information handling system, according to embodiments of the present disclosure. It will be understood that the functionalities shown for system 600 may operate to support various embodiments of the present disclosure—although it shall be understood that such a system may be differently configured and include different components, additional components, or fewer components.

The information handling system 600 may include a plurality of I/O ports 605, a plurality of network processing units (NPU) (or forwarding elements) 615 and one or more tables 620. In one or more embodiments, the system 600 may also include one or more CPUs 625. The system includes a power supply (not shown) and may also include other components, which are not shown for sake of simplicity.

In one or more embodiments, the I/O ports 605 may be connected via one or more cables to one or more other network devices or clients. Each forwarding element of the plurality of forwarding elements 615 may use information included in the network data received at the node 600, as well as information stored in tables 620, to identify a next device for the network data, among other possible activities. In one or more embodiments, a switching fabric may schedule the network data for propagation through the node to an egress port for transmission to the next destination.

In one or more embodiments, the CPU and NPU functionality may be integrated and provided by a chiplet or chiplets. Chiplets allow for the creation of more complex integrated circuits by combining multiple smaller components, each serving a specific function or functions, which may be combined to form a system-on-a-chip (SoC).

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

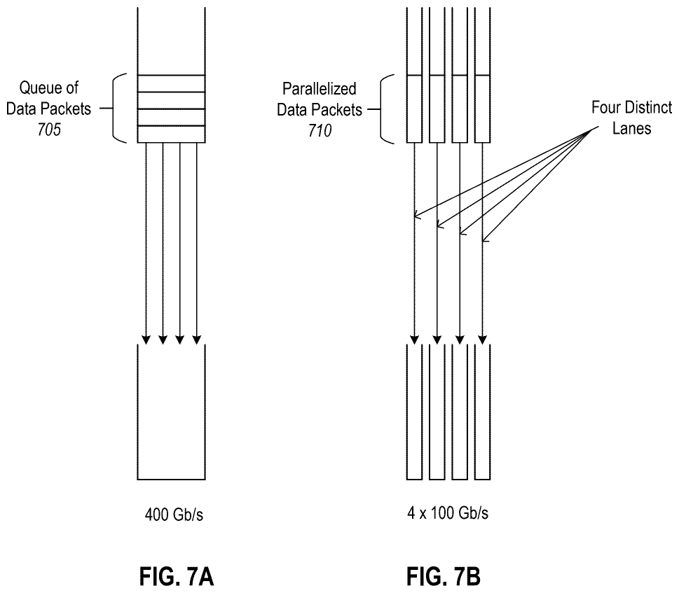

Embodiments herein use fewer network information handling systems (e.g., switches) without complicated host cabling by using high-speed cables implemented as a set of parallel lanes operating at lower speeds than the top speed for a port. For example, a 400 Gb/s Ethernet link may be implemented using four lanes at 100 Gb/s that effectively act as a single 400 GB/s link, as shown in FIG. 7A, which may also be referred to a rail configuration or rail switch. As shown in FIG. 7B, for traffic that may be parallelized (such as AI/ML traffic), a configuration of four parallel Ethernet links, each at 100 Gb/s, may provide similar performances as a single Ethernet link at 400 Gb/s.

Cables for parallel Ethernet links use connectors supporting parallel lanes, such as OSFP (Octal Small Format Pluggable) or QSFP (Quad Small Form-factor Pluggable). These cables may be used not just to support the high-speed link shown in FIG. 7A in which they act as a single link, but also the configuration of four parallel, distinct links as shown in FIG. 7B.

In one or more embodiments, a network information handling system (e.g., an Ethernet switch) may be configured to incorporate multiple forwarding elements (e.g., multiple network processor ASICs or FPGAs) arranged in a parallel configuration, which enables the advantages of the structure shown in FIG. 4 without complicating the host cabling.

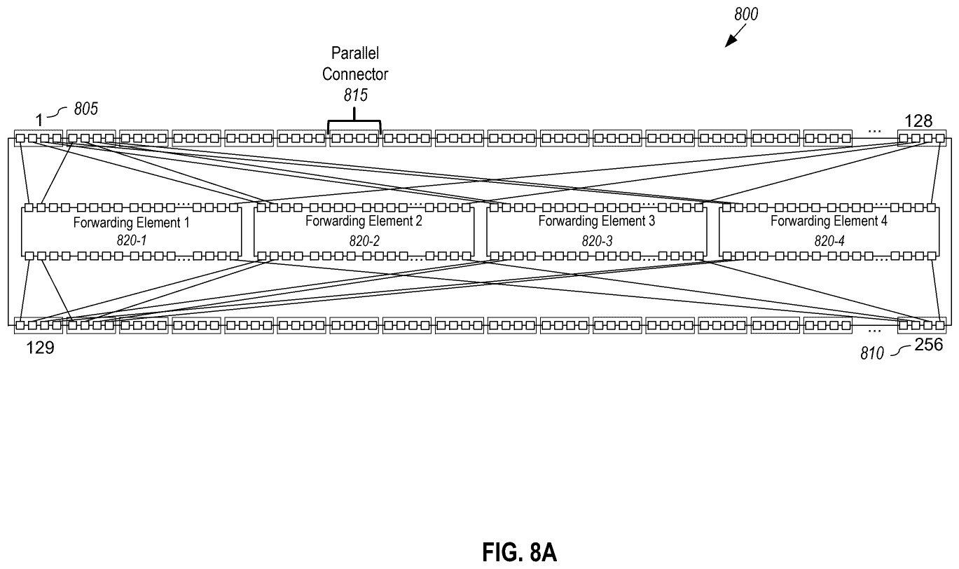

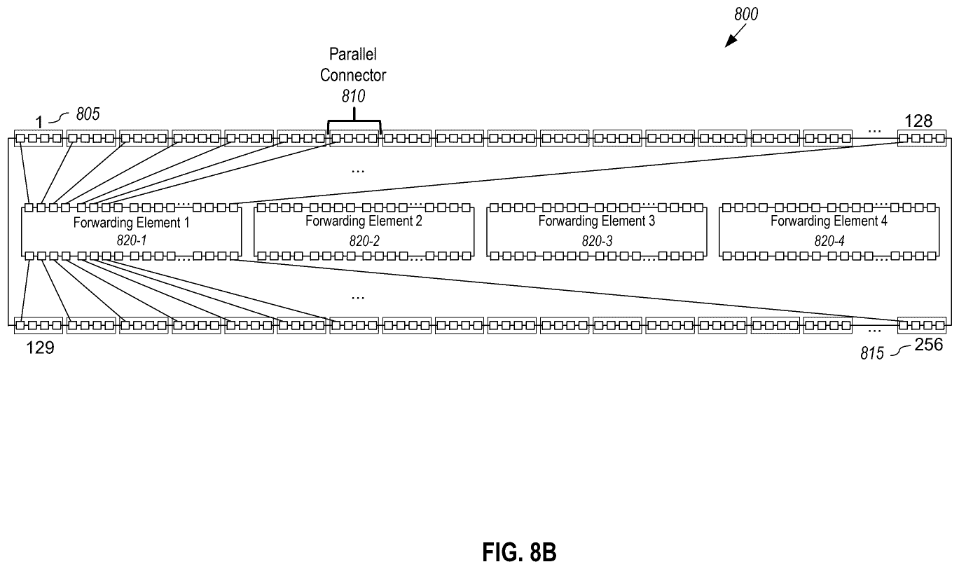

FIG. 8A shows how to build such a network information handling system comprising four forwarding elements, according to embodiments of the present disclosure. Depicted in FIG. 8A is an information handling system 800 for handling network data traffic. The network information handling system 800 comprises four network processing units/forwarding elements 820-1 through 820-4. In the depicted embodiment, the network information handling system comprises 256 externally accessible ports (e.g., port 1 805 through port 256 810) for connecting with other information handling systems. Each port can support up to four distinct parallel connection/communication lanes 815 (e.g., QSFP). The forwarding elements 820 are configured in a parallel configuration, in which, for this embodiment, each forwarding element 820 is connected to each port. For example:
the first lane of each port of the network information handling system is internally connected to a port of the first forwarding element 820-1;
the second lane of each port of the network information handling system is internally connected to a port of the second forwarding element 820-2;
the third lane of each port of the network information handling system is internally connected to a port of the third forwarding element 820-3, and
the fourth lane of each port of the network information handling system is internally connected to a port of the fourth forwarding element 820-4

Such a configuration creates an internal or closed parallel configuration within the network information handling system that supports parallelized handling of data. FIG. 8B depicts an alternate view of the network information handling system 800, according to embodiments of the present disclosure, in which some connections of just one forwarding element (i.e., forwarding element 820-1) are depicted. For both FIG. 8A and FIG. 8B, only some of the connections between lanes of ports of the network information handling system and the ports of the forwarding elements are depicted to reduce confusion caused by excessive connections and thereby aid clarity in understanding of the implementation concept.

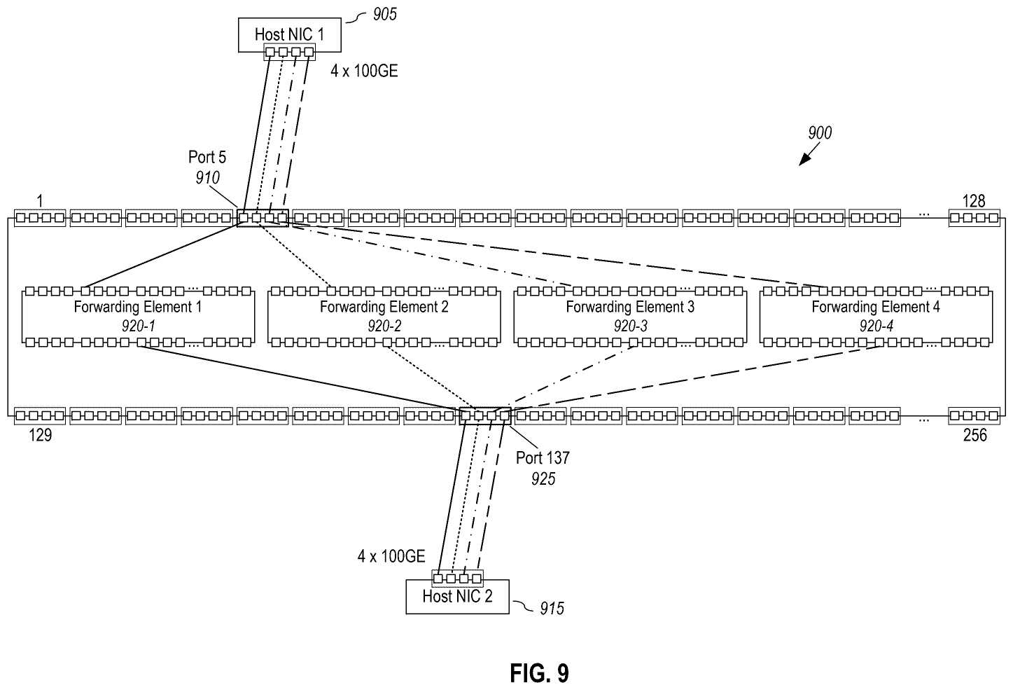

Thus, FIGS. 8A & 8B depict an Ethernet parallel switch embodiment with four network processors 820 and with 256 external parallel connectors/ports with each connector/port supporting four parallel lanes operating at 100 Gb/s. Note that the arrangement of the internal connections of the switch external ports to the network processor ports enables such a switch to work correctly with existing parallel cables—each lane of a parallel connector is connected to a different internal network processor 820, as shown in FIG. 8A and FIG. 8B. The resulting end-to-end configuration is shown in FIG. 9.

As depicted in FIG. 9, a network information handling system 900 comprises four forwarding elements 920. Host 1 connects via a port on its network interface card (NIC) 905 to a port (i.e., Port 5 910) of the network information handling system 900. Note that the port comprises four distinct lanes, and each distinct lane connects within the network information handling system 900 to a corresponding forwarding element 920, as illustrated in FIG. 9. Similarly, a second host connects via a port on its NIC 915 to a port (i.e., Port 137 925) of the network information handling system 900, and each lane of Port 137 has a corresponding parallel connection within the network information handling system 900 to a corresponding forwarding element 920.

On the host side, the four 100 gigabit Ethernet (GE) lanes supported by the host NIC use a single 4-lane cable to connect to the externally accessible connector/port of the network information handling system 900. Inside the network information handling system 900, the four internal network processor units 920 may be programmed with the same forwarding tables. Thus, this network information handling system 900 is in a parallel switch configuration and is equivalent to a 256×400GE port switch from a bandwidth standpoint.

From a network point of view, being a closed parallel system, it may be managed in at least two different ways. In one or more embodiments, the system may expose its internal parallelism and be managed as an n-way parallel fabric system, in which, for example, each of the four 100GE lanes of the host may be configured with its own IP (Internet Protocol) address (i.e., individually addressed) and uses a separate ARP (Address Resolution Protocol) process to resolve the IP addressing. Here, the “n” in n-way relates to the number of distinct parallel lanes per port that are used. Alternatively, or additionally, in one or more embodiments, the system may hide its internal parallelism and be managed using link teaming (e.g., link aggregation) on the host side, for example by assigning a single IP address to the set of four 100GE lanes of the host and using a single ARP process for that set of four 100GE lanes.

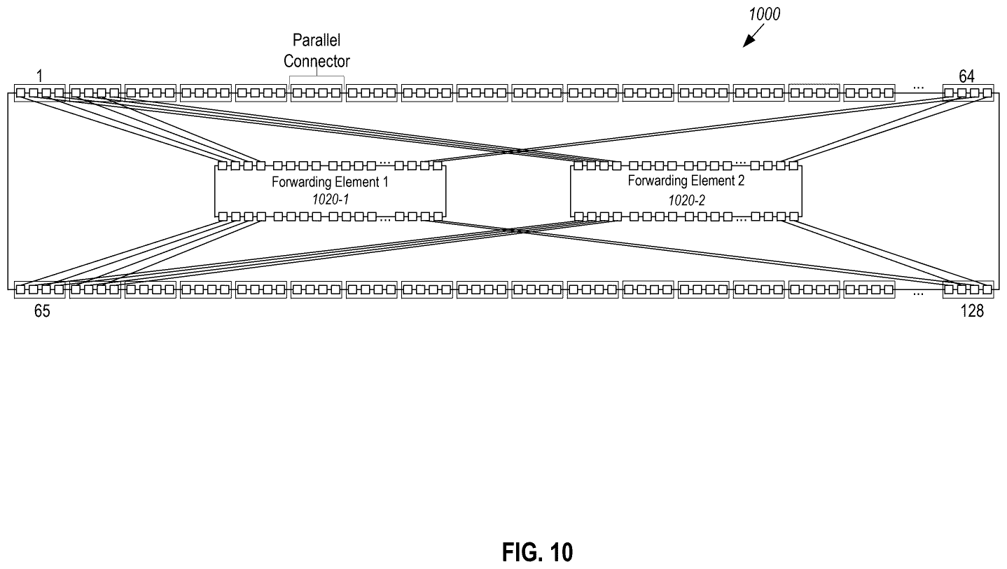

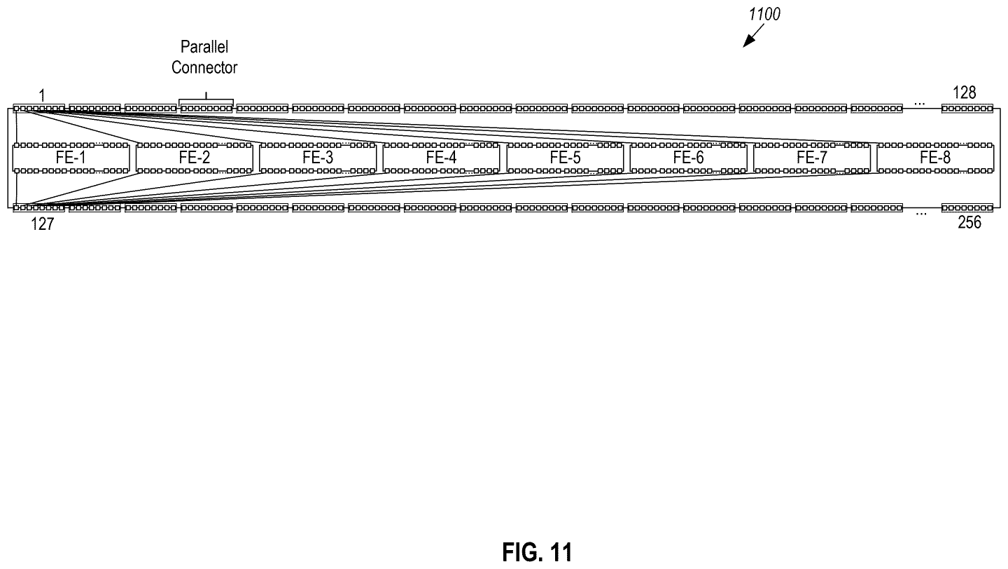

In one or more embodiments, the parallel switch arrangement concept illustrated in FIGS. 8A, 8B, and 9 may be generalized to configurations having different numbers of internal forwarding elements/network processing units (e.g., 2 forwarding elements, 8 forwarding elements, etc.) and may operate at different speeds. Consider, for example, the sample embodiments depicted in FIG. 10 and FIG. 11.

FIG. 10 illustrates a network information handling system that can operate as an Ethernet parallel switch, according to embodiments of the present disclosure. The depicted embodiment comprises two forwarding elements (i.e., forwarding elements 1020-1 and 1020-2) and comprises 128 external connectors (e.g., QSFP pluggable modules), each supporting four lanes operating at 100 Gb/s. In one or more embodiments, the lane connections between the external ports and the internal port connections of the forwarding elements may be configured to alternate. For example, for a port, lanes 1 and 3 may connect to forwarding element 1 1020-1 and lanes 2 and 4 may connect to forwarding element 2 1020-2. In one or more embodiments, the host may group lanes that are configured to the same forwarding elements as a link aggregation group. In one or more alternative embodiments, the lanes connections to the forwarding element may not alternate.

FIG. 11 illustrates a network information handling system that can operate as an Ethernet parallel switch that has eight forwarding elements, according to embodiments of the present disclosure. The depicted embodiment comprises eight forwarding elements (i.e., forwarding elements 1-8) and with 256 external parallel connectors, each supporting eight lanes operating at 100 Gb/s. In one or more embodiments, the externally accessible ports may comprise using a transceiver or pluggable module. Transceivers or pluggable modules may be used by the network information handling system, a host information handling system, or both.

For applications that has data that may be parallelized for handling, such as AI/ML applications, the parallel Ethernet switch configurations shown in FIG. 10 is equivalent to a 128×400GE switch, and the parallel Ethernet switch shown in FIG. 11 is equivalent to a 256×800GE switch.

It shall be noted that, in one or more embodiments, not all of the lanes need to be utilized. For example, depending upon the need, only two lanes out of four lanes may be used to connect to two forwarding elements of a network information handling system that comprises a plurality of forwarding elements.

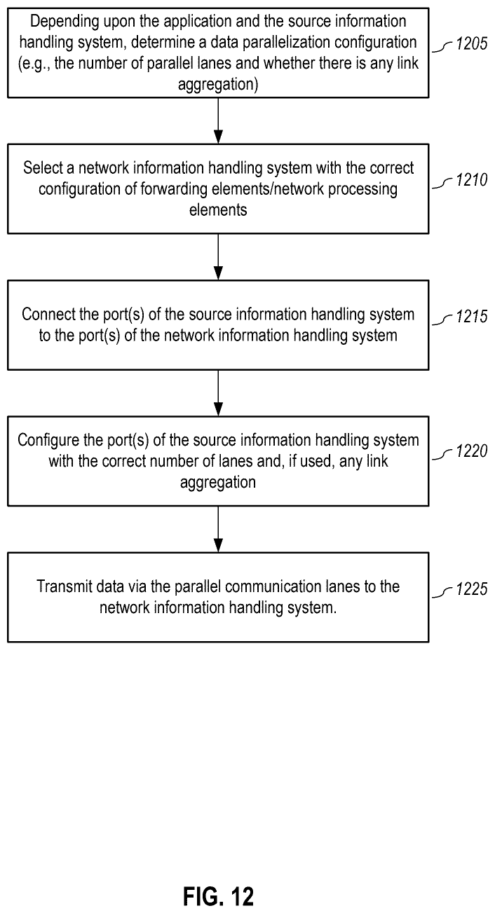

FIG. 12 depicts a methodology for deploying and using a network information handling system in a parallel switch configuration, according to embodiments of the present disclosure. As a preliminary matter, the correct configuration should be assessed. In one or more embodiments, depending upon the application and the source information handling system (e.g., a host system), one may determine (1205) a data parallelization configuration. Factors that may be considered include, but are not limited to, bandwidth desired, amount of parallelization (e.g., the number of parallel lanes), and whether any link aggregation will be used. For example, it may be determined that four distinct, parallel lanes may be supported, and the bandwidth of each lane may be 100 GB/s.

Given that information, a corresponding network information handling system with a plurality of forwarding elements and the correct speed may be selected. In one or more embodiments, the network information handling system (which can act as an Ethernet parallel switch) has a configuration correlation between the number of lanes (n lanes) of an externally accessible connector on the network information handling system and internal forwarding elements. For example, in one or more embodiments, an n-lane connector of the network information handling system can support internal connections to:
n internal forwarding elements (e.g., network processor ASICs, network processing FPGA, NPU, SoC, etc.), connecting one lane to a port of each forwarding element;
n/2 internal forwarding elements, connecting two lanes to two ports of each forwarding element (if n is divisible by 2);
n/3 internal forwarding elements, connecting three lanes to three ports of each forwarding element (if n is divisible by 3);
n/4 internal forwarding elements, connecting four lanes to four ports of each forwarding element (if n is divisible by 4);
etc.

For example, a 4-lane connector of a network information handling system enables internal configurations with two or four network processor ASICs (as shown in FIG. 10 and FIG. 8A/FIG. 8B, respectively). Or, for example, an 8-lane connector of a network information handling system (or 2×4-lane switch connectors) enables internal configurations with two, four, or eight internal forwarding elements (e.g., FIG. 10, FIG. 8A/FIG. 8B, and FIG. 11, respectively).

In one or more embodiments, the configuration relationship may be considered as follows: each forwarding element is communicatively coupled to each externally accessible port of a set of externally accessible ports such that the quotient of the number of distinct connection lanes divided by the number of forwarding elements is an integer. In one or more embodiments, a deployment may be based upon a power of 2 for the number of lanes.

In one or more embodiments, more forwarding elements may exist in a network information handling system than lanes used by a host information handling system. For example, a switch may have 8 forwarding elements, but a host application may use fewer than the 8 forwarding elements (e.g., 4 forwarding element or 3 forwarding elements). While such an embodiment may be deployed, it does not efficiently utilize the switch's resources and may result in increased overall costs due to the unused capacity.

Having ascertained the parallelization configuration requirement, a corresponding network information handling system with the correct configuration of forwarding elements/network processing elements may be selected/utilized (1210).

In one or more embodiments, the port or ports of the source information handling system may be connected (1215) to port(s) of the network information handling system. Endpoints may be connected to the network information handling system by using existing hardware (e.g., multi-lane cables, connectors, and/or transceivers)-thereby avoiding all issues related with the handling of breakout cables or of multiple cables, as shown in FIG. 4.

The port or ports of the source information handling system may be configured (1220) with the correct number of lanes. That is, in one or more embodiments, endpoints configure their ports to operate as n links at lower speed (e.g., a 400GE capable NIC is configured as 4×100GE links) with n correlated with the rail switch configuration.

Also, in one or more embodiments, depending upon the implementation and configuration, these n links may be handled with link aggregation on the endpoint side. Thus, any link aggregation groups may also be configured. Consider, by way of illustration, the following scenarios. Assuming a network information handling system like that depicted in FIG. 10 is selected, in which it has two forwarding elements, but its ports can support up to four parallel lanes. If the source information handling system's application (i.e., host's application) only needs two parallel lanes, the port may be configured to have two sets of two parallel lanes, in which each set of parallel lanes is configured as a link aggregation group.

Finally, once connected and configured, the source information handling system may transmit data via the parallel communication lanes to the network information handling system.

It shall be noted that the connecting and configuration steps may be performed in different orders. It shall also be noted that, while not depicted in FIG. 12, a similar connection and configuration process may be performed for any destination information handling systems.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A network information handling system comprising:
a plurality of externally accessible ports for connecting to one or more information handling systems, in which each externally accessible port of a set of the externally accessible ports from the plurality of externally accessible port is configured to connect via a plurality of distinct connection lanes to a port of an information handling system; and
a plurality of forwarding elements, in which each forwarding element is communicatively coupled to each externally accessible port of the set of externally accessible ports for at least one lane of the externally accessible port to enable parallel handling of the plurality of distinct connection lanes from the information handling system by the plurality of forwarding elements.

2. The network information handling system of claim 1 wherein each forwarding element comprises a same forwarding table for communications between a source information handling system and a destination information handling system that utilize the plurality of distinct connection lanes of the network information handling system.

3. The network information handling system of claim 1 wherein a forwarding element is a network processing unit, a field-programmable gate array, an application specific integrated circuit, a chiplet, or a system-on-a-chip (SoC).

4. The network information handling system of claim 1 wherein each forwarding element is configured to support its maximum number of externally accessible ports.

5. The network information handling system of claim 1 wherein each connection lane is individually addressed for data traffic handling.

6. The network information handling system of claim 1 wherein an externally accessible port comprises a transceiver or pluggable module.

7. The network information handling system of claim 1 wherein a quotient of the number of distinct connection lanes of an externally accessible port of the network information handling system divided by the number of forward elements of the network information handling system is an integer.

8. The network information handling system of claim 1 wherein data received via the connection lane is for an application that supports parallelized data handling.

9. A method for parallel handling of data comprising:
configuring a port of a source information handling system to support a number n of communication lanes for that port:
connecting the port of the source information handling system to a port of network information handling system that comprises plurality of forwarding elements, in which at least two lanes of the communication lanes of the port are communicatively coupled to at least two forwarding elements within the network information handling system; and
transmitting data via the communication lanes of the port to the corresponding forwarding elements of the network information handling system for parallel data handling.

10. The method of claim 9 further comprising:
dividing data into the communication lanes corresponding to the number of communication lanes used by the port of the source information handling system.

11. The method of claim 9 wherein:
two or more communication lanes of the port are treated as a link aggregation group.

12. The method of claim 9 wherein the network information handling system to which the source information handling system connects was selected based upon the number of forwarding elements of the network information handling system.

13. The method of claim 12 wherein the network information handling system comprises the number of forwarding elements such that the number of communication lanes of the port divided by the number of forward elements has a quotient that is an integer.

14. The method of claim 9 wherein the port comprises a transceiver or pluggable module.

15. A network information handling system comprising:
a plurality of ports for connecting to one or more information handling systems, in which each port of a set of the ports from the plurality of port is configured to connect via a plurality of lanes to a same port of an information handling system; and
a plurality of forwarding elements, in which, for each port of the set of the ports from the plurality of port, at least two lanes of the port of the network information handling system are communicatively coupled to at least two forwarding elements within the network information handling system.

16. The network information handling system of claim 15 wherein, for the port, each forwarding element of the least two forwarding elements comprises a same forwarding table for communications between a source information handling system and a destination information handling system that utilize the port of the network information handling system.

17. The network information handling system of claim 15 wherein a forwarding element is a network processing unit, a field-programmable gate array, or an application specific integrated circuit, a chiplet, or a system-on-a-chip (SoC).

18. The network information handling system of claim 15 wherein each forwarding element is configured to support its maximum number of externally accessible ports.

19. The network information handling system of claim 15 wherein each lane is individually addressed for data traffic handling.

20. The network information handling system of claim 15 wherein an externally accessible port comprises a transceiver or pluggable module.
